(19) United States
(12) Patent Application Publication
(10) Pub. No.: US 2018/0226052 A1
(43) Pub. Date: Aug. 9, 2018

(54) CONTROL METHOD AND CONTROL APPARATUS FOR DISPLAY DEVICE, AND DISPLAY DEVICE

(71) Applicants: BOE TECHNOLOGY GROUP CO., LTD., Beijing (CN); BEIJING BOE MULTIMEDIA TECHNOLOGY CO., LTD., Beijing (CN)

(72) Inventor: Bendeng LV, Beijing (CN)

(21) Appl. No.: 15/571,378

(22) PCT Filed: Mar. 7, 2017
(86) PCT No.: PCT/CN2017/075883

§ 371 Date: Nov. 2, 2017

(30) Foreign Application Priority Data
Jun. 29, 2016 (CN) 201610500242.6

(51) Int. Cl. G09G 5/00

(52) U.S. Cl. CPC G09G 5/006; G09G 2340/0407; G09G 2370/047; G09G 2360/02

(57) ABSTRACT

This application provides a control method and a control apparatus for a display device, and the display device corresponding thereto. The control method includes: selecting, according to a data format of an acquired video signal, extended display identification data EDID information matching with the data format; and controlling the display device to display the video signal in a corresponding data format according to the selected EDID information. With the control method, control apparatus, and the display device according to the embodiments of the present disclosure, it is possible to select, according to a data format of a signal inputted from the source device or a data format inputted by the user, matching EDID data, so as to be used by the display device when displaying the video signal.

### TECHNICAL FIELD

The present disclosure relates to the technical field of display, and more particularly to a control method and a control apparatus for a display device, and the display device corresponding thereto.

### BACKGROUND

Recently, digital video has become quite popularized, and digital video provided by a multimedia source (e.g., a set-top box, a DVD player, and a PC) can typically be transmitted to a video display device (e.g., a TV) via a digital interface, so as to display digital video received from the multimedia source. The digital interface may be a digital video interface (DVI) or a high-definition multimedia interface (HDMI) etc. Taking the HDMI interface as an example, an HDMI source device (HDMI SOURCE), such as DVD player, set-top box (STB), Blu-ray player etc., is connected to an HDMI receiving device (HDMI SINK), such as display device TV, via the HDMI interface.

In general, information related to control information is described in extended display identification data EDID at the HDMI receiving device, such as the display device. EDID is a VESA standard data format and configured to enable the display device to support the Plug and Play functionality. EDID describes display property and display capability of the display device itself. The source device (e.g. PC, DVD, STB etc.) outputs a signal format supported by the display device according to a corresponding attribute value of EDID.

As technology develops, a display device supporting multi-channel HDMI input has emerged. However, in the conventional display device, EDID corresponding to each channel of HDMI is fixed, and when inputted HDMI data in a certain channel does not match with the corresponding EDID data, a compatibility problem occurs, which results in malfunctions such as device down.

### SUMMARY

According to an aspect of the present disclosure, there is provided a control method for a display device, the control method comprises: selecting matching EDID (extended display identification data) information according to a data format of an acquired video signal; and controlling the display device to display the video signal in a corresponding data format according to the selected EDID information.

Optionally, according to an embodiment of the present disclosure, the acquired data format includes a resolution corresponding to the video signal.

Optionally, according to an embodiment of the present disclosure, the control method further comprises: analyzing a data format of an inputted video signal from a source device, and selecting corresponding EDID information according to the analyzed data format.

Optionally, according to an embodiment of the present disclosure, the source device may provide information on the data format of the inputted video signal to the display device in an explicit or implicit manner.

Optionally, the stored EDID information may be displayed to the user, so as for the user to select the matching data format to be used by the display device to display the video signal. Optionally, video input definition, horizontal image size, vertical image size, color property, timing, and display transmission property etc. may be displayed to the user. Thereby, the user may modify the displayed EDID information as needed, and store the modified EDID information.

Optionally, according to an embodiment of the present disclosure, the resolution format supported by the display device may be displayed to the user, so as for the user to select the data format to be used by the display device to display the video signal.

Optionally, according to an embodiment of the present disclosure, when a resolution of the inputted video signal is higher than a resolution supported by the display device, the display device may be set to display the video signal at the highest resolution supported by the display device

Optionally, according to an embodiment of the present disclosure, in the case where the EDID information matching with the resolution of the inputted video signal is not stored, the display device may be set to display at a resolution closest to the resolution of the inputted video signal as supported by the display device. In this case, distortion caused during displaying of the video signal from the source device can be minimized, and compatibility with the source device can be ensured maximally.

Optionally, according to an embodiment of the present disclosure, the user-selected EDID information may be provided to the source device, so that the source device can adjust the resolution format of the video signal inputted to the display device in real time, thus ensuring that the inputted video signal matches with the resolution selected by the user and improving compatibility with the display device.

According to another aspect of the present disclosure, there is provided a control apparatus for a display device. The control apparatus comprises: a selector configured to select, according to a data format of an acquired video signal, EDID (extended display identification data) information matching with the data format; and a reader-writer connected to the selector and configured to read the selected EDID information, so as for the display device to display the video signal according to the read EDID information.

Optionally, according to an embodiment of the present disclosure, the control apparatus may further comprise a memory in which at least one item of EDID information supported by the display device is stored.

Optionally, according to an embodiment of the present disclosure, each item of EDID information corresponds to one video signal data format, and the supported timing and bandwidth range are different.

Optionally, the memory may be located outside the control apparatus as a separate memory device and communicate with the control apparatus via a bus.

Optionally, according to an embodiment of the present disclosure, the control apparatus further comprises a data analyzer connected to the selector and configured to analyze a data format of a video signal inputted from a source device, and sending an analysis result to the selector.

Optionally, the control apparatus further comprises a communication interface connected to the source device and the data analyzer and configured to receive the video signal inputted from the source device and supplying the video signal to the data analyzer.

Optionally, according to an embodiment of the present disclosure, the data format includes a resolution corresponding to the video signal.

Optionally, according to an embodiment of the present disclosure, the reader-writer is further connected to the memory and configured to read the EDID information stored in the memory according to the user's instruction and sending the EDID information to the display device. Thereby, the stored EDID information can be displayed to the user, so as for the user to select or preset the EDID information to be used by the display device.

Optionally, according to an embodiment of the present disclosure, the reader-writer is further connected to the memory and configured to write the modified EDID information into the memory according to a modification made by the user to the EDID information displayed on the display device. Thereby, the EDID information stored in the memory may be modified according to the setting made by the user.

Optionally, according to an embodiment of the present disclosure, when a resolution of the inputted video signal is higher than a resolution supported by the display device, the selector selects the highest resolution supported by the display device for the display device to display.

Optionally, according to an embodiment of the present disclosure, when the EDID information matching with the resolution of the inputted video signal is not stored, the selector selects a resolution closest to the resolution of the inputted video signal as supported by the display device, for the display device to display.

Optionally, according to an embodiment of the present disclosure, when the user-selected EDID information is received, the reader-writer supplies the selected EDID information to the source device via a communication interface, so that the source device modifies the data format of the outputted video signal according to the EDID information. Thereby, the source device is made to correspondingly modify the data format of the signal outputted to the display device according to the stored EDID information, so as to be compatible with the display device.

According to another aspect of the present disclosure, there is provided a control apparatus for a display device. The control apparatus comprises a selector configured to select, according to a data format of an acquired video signal, stored EDID (extended display identification data) information matching with the data format; and a controller connected to the selector and configured to control, according to the selected EDID information, the display device to display the video signal in a corresponding data format.

Optionally, the control apparatus further comprises a data analyzer connected to the controller and configured to analyze a data format of an inputted video signal, and sending an analysis result to the controller.

Optionally, the controller controls, according to the analyzed data format, the selector to select the stored matching EDID information for the source device to read, and to select a proper resolution for the display device to display the video signal.

Optionally, the control apparatus further comprises a graphical user interface (GUI) configured to display the stored EDID information to the user for the user to select, and presetting or adjusting the EDID information as need by the user.

Optionally, the controller may control, according to the data format selected by the user on the user interface, the selector to select the matching EDID information stored in the memory for the source device to read, and to select a proper resolution for the display device to display the video signal.

Optionally, the controller may modify the EDID information stored in the memory according to the EDID information inputted by the user, so as to adjust the EDID setting for the display device promptly as needed.

According to an embodiment of the present disclosure, there is provided a display device, comprising the control apparatus as described above.

According to an embodiment of the present disclosure, it is possible to store a plurality of EDID data in advance to correspond to different data formats of the video signal respectively, and select, according to a data format of a signal inputted from the source device or a data format inputted by the user, matching EDID data for the display device to use. In this way, compatibility between the display device and the source device is improved, and display resolution of the display device can be utilized maximally.

### BRIEF DESCRIPTION OF THE DRAWINGS

In order to more clearly illustrate the technical solutions of the embodiments of the present disclosure, hereinafter, the drawings necessary for illustration of the embodiments of the present application will be introduced briefly. It is apparent that the drawings described below are related to only some embodiments of the present disclosure, and should not be construed as limiting the present disclosure.

FIG. 1 is a block diagram of a video system according to an exemplary embodiment of the present disclosure;

FIG. 2 is a flowchart of a control method for a video device according to an exemplary embodiment of the present disclosure;

FIG. 3 illustrates a menu of EDID items that are displayed on a display interface of a video device and can be set by the user according to an exemplary embodiment of the present disclosure;

FIG. 4 illustrates a menu of resolutions that are displayed on a display interface of a video device and can be set by the user according to an exemplary embodiment of the present disclosure;

FIG. 5 illustrates a flowchart of modifying EDID of a display device according to an exemplary embodiment of the present disclosure;

FIG. 6 is a block diagram of a video device according to an exemplary embodiment of the present disclosure; and

FIGS. 7A-7B are block diagrams of a control apparatus for a display device according to an exemplary embodiment of the present disclosure.

### DETAILED DESCRIPTION OF THE EMBODIMENTS

Hereinafter, the embodiments of the present disclosure will be described clearly and comprehensively in combination with the drawings. Obviously, these described embodiments are merely parts of the embodiments of the present disclosure, rather than all of the embodiments thereof. Other embodiments obtained by a person of ordinary skill in the art based on the embodiments of the present disclosure without paying creative effort all fall into the protection scope of the present disclosure.

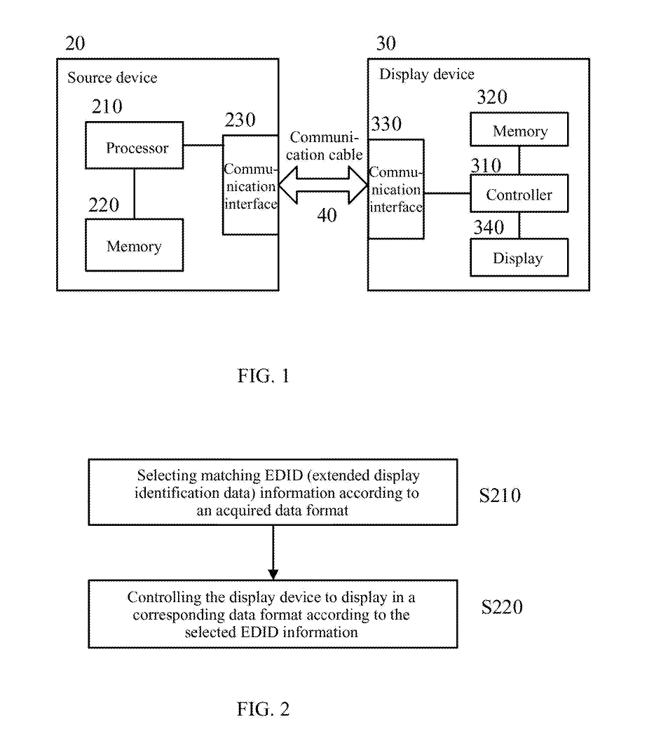

FIG. 1 illustrates a block diagram of a video system according to an exemplary embodiment of the present disclosure. As shown in FIG. 1, the video system 10 comprises a source device 20 and a display device 30 connected to each other via a digital cable 40. In the following embodiments, the principle of the embodiments of the present disclosure is explained by taking an HDMI interface as an example for ease of discussion. However, it should be noted that this principle is not limited to the video system using the HDMI interface, but can be applied to other digital interfaces, such as the video system using a DVI interface.

As an example, the source device 20 comprises a processor 210, a memory 220, and an HDMI communication interface 230. The processor 210 is connected to the memory 220 and the HDMI communication interface 230 via a bus, and controls operations of the memory 220 and the HDMI communication interface 230. The memory 210 stores, for example, control program and setting information on video/audio of the source device 20. The memory 210 may be a flash memory, a hard disk drive, a DVD drive or the like. The communication interface 230 transmits the video/audio signal to the display device 30, sends relevant control commands to the display device 30 and receives relevant requests from the display device 30, via a digital cable, such as an HDMI cable.

The display device 30 outputs a video/audio signal from the source device, for example, the display device 30 may be a television set, a projector, a monitor, or other display device. As an example, the display device 30 comprises a controller 310, a memory 320, a communication interface 330, and a display component 340. The controller 310 connects the memory 320, the communication interface 330, and the display component 340 via a bus, and controls operations of the memory 320, the communication interface 330, and the display component 340. The memory 320 stores, for example, control program and video/audio setting, such as EDID information, of the display device 30. The memory 320 may be an EEPROM, a FLASH, a hard disk drive, or the like. The communication interface 330 receives the video/audio signal and the relevant control commands transmitted from the source device 20 via the digital cable, and may send a request to the source device 20. The display component 340 displays the video signal processed by the controller 310 to the user and may also serve as a human-machine interface via which the user can view and change relevant settings of the display device 30, for example, view the EDID settings and make modifications. Although the display component 340 is illustrated as being integrated inside the display device 30 in FIG. 1, it is to be understood that, according to the requirement, the display component 340 may be absolutely connected as an independent component to the display device via a signal cable, such an implementation being not departing from the principle of the present disclosure.

As described above, extended display identification data EDID is usually stored in the memory 320 of the display device, wherein EDID contains identification information of the display device itself and content such as video format/attribute supported by the display device, for example, EDID includes resolution, color space, and availability of an HDMI mode supported by the display device. The source device may use the information on EDID to configure a graphical subsystem, and an application software program may also use some information in EDID. For the sake of proper operations, usually it must be ensured that the source device can read content of EDID when the display device is turned on or off. Usually, the source device reads EDID from the display device when the source device is connected to the display device by use of the HDMI cable to enable data transmission. As described above, in order to ensure compatibility between the display device adopting multi-channel HDMI input and the source device, EDID can be switched as needed to match with the corresponding HDMI input, thus avoiding possible malfunctions such as crash of the video system. For example, when the display device supports a 4K resolution, the corresponding 4K timing is added to EDID, and the corresponding supportable HDMI bandwidth and frequency are added. When the source device reads the data, there may be incompatibility or crash, which needs to replace EDID data of the display device to re-match with the source device, so that compatibility between the two can be ensured. However, since EDID corresponding to each channel of HDMI is fixed in the current device, and EDID switching is not supported, compatibility cannot be guaranteed.

In order to solve the above problem, according to the principle of the present disclosure, a plurality of EDID data may be stored in advance in the memory of the display device, corresponding to the different data format of the video signal, respectively, and the matching EDID data may be selected according to the inputted data format. In this way, compatibility between the display device and the source device is improved, and display resolution of the display device can be utilized maximally.

For ease of discussion, the principle of the present disclosure is described in detail below primarily based on switching resolution in EDID information. It should be noted, however, that the principle of the present disclosure is not limited to switching resolution of the display device only, but may be extended to switching other information contained in EDID as needed, for example, switching other information such as control timing, chroma space, display type, etc. For example, with 4K TV as an example of the display device, settings may be made in EDID with respect to the 4K timing and the supported corresponding HDMI bandwidth and frequency.

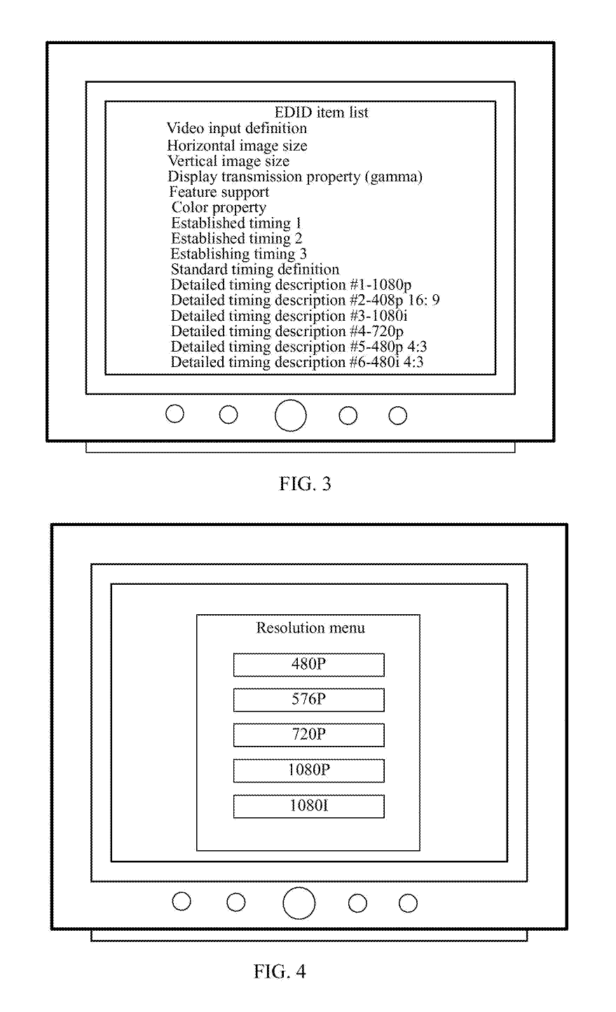

A control method for a display device according to an embodiment of the present disclosure will be described in detail with reference to FIG. 2 below. As shown in FIG. 2, the control method comprises: S210, selecting, according to the acquired data format, EDID (extended display identification data) information matching with the data format; and S220, controlling the display device to display the video signal in a corresponding data format according to the selected EDID information.

Optionally, according to an embodiment of the present disclosure, the acquired data format comprises a resolution corresponding to the video signal.

Optionally, according to an embodiment of the present disclosure, the control method further comprises: analyzing a data format of an inputted video signal and selecting the corresponding EDID information according to the analyzed data format. By way of example, the controller 310 in the display device determines the matching EDID information by analyzing the signal received via the communication interface 330 from the source device 20. In this way, EDID setting of the display device that matches the video signal inputted from the source device can be automatically selected without user intervention. By way of example, the source device may provide information on the data format of the inputted video signal to the display device in an explicit or implicit manner.

As another manner, for example, as shown in FIG. 3, the stored EDID information may be displayed on the display component of the display device to the user, so as for the user to select the matching data format to be used by the display component. As an example, video input definition, maximum horizontal image size, maximum vertical image size, color property, timing, and display transmission property may be displayed to the user. Optionally, the user may modify the displayed EDID information as needed, and the controller 310 stores the modified EDID information in the memory 320.

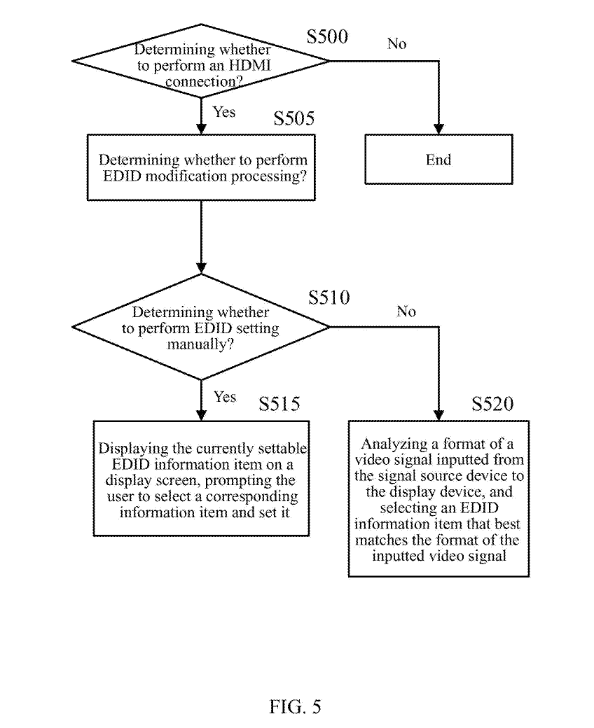

Optionally, according to an embodiment of the present disclosure, as shown in FIG. 4, the resolution format supported by the display device may be displayed to the user on the display component of the display device, so as for the user to select the resolution format to be used by the display component.

Optionally, according to an embodiment of the present disclosure, the display device may be arranged to display the video signal at the highest resolution when a resolution of the inputted video signal is higher than a resolution supported by the display device. In particular, if the processor 310 in the display device determines that the resolution of the inputted video signal is higher than the highest resolution supported by the display component of the display device after analyzing the signal received from the source device 20, the video signal from the source device is displayed at the highest resolution.

Optionally, according to an embodiment of the present disclosure, when EDID information matching with the resolution of the inputted video signal is not stored in the memory 320, in other words, when the controller 310 has not found EDID information matching with the resolution of the inputted video signal, the display component may be set to display at a resolution closest to the resolution of the inputted video signal. In this case, distortion caused during displaying of the video signal from the source device can be minimized, and compatibility with the source device can be ensured maximally.

The above description is selecting or modifying the EDID information stored in the display device according to the video signal outputted from the source device or the data format inputted by the user, thereby ensuring compatibility between the display device and the source device. As another manner, optionally, the user-selected EDID information may be provided to the source device via the communication interface 330, so that the source device modifies the data format of the video signal outputted to the display device according to the EDID information. For example, as shown in FIG. 4, when the user selects a corresponding resolution based on, for example, a resolution list displayed on the display component, the selected resolution is transmitted to the source device via, for example, a communication interface of the display device, so that the source device can adjust the resolution format of the video signal inputted to the display device in real time, thus ensuring that the inputted video signal matches with the resolution selected by the user and improving compatibility with the display device.

FIG. 5 illustrates a flowchart of a method for modifying EDID of a display device according to an exemplary embodiment of the present disclosure. As shown in FIG. 5, at S500, the display device determines whether to perform an HDMI connection; at S505, it is determined whether it is required to perform EDID modification processing after determining to perform an HDMI connection; at S510, it is determined whether to perform EDID setting manually if EDID modification processing is required; at S515, in the case of that EDID setting is performed manually, a currently settable EDID information item is displayed on a display screen, the user is prompted to select a corresponding information item and set it, and the set information item is written to the memory (it may be a memory integrated inside the display device, or it may be an external memory); when it is determined that the EDID information is not set manually, it is necessary to perform EDID setting automatically, at S520, a format of a video signal inputted from the source device to the display device is analyzed, and compared with the stored EDID information item, to select the EDID information item that best matches with the format of the inputted video signal as the EDID setting for the display component to display the video signal; or, although not shown in the figures, the selected EDID information item may also be sent to the source device, thereby enabling the source device to adjust the data format of the video signal transmitted to the display device, so as to ensure compatibility between the source device and the display device.

FIG. 6 illustrates a control apparatus for a display device according to an exemplary embodiment of the present disclosure. As shown in FIG. 6, the control apparatus may comprise a selector 610 for selecting, according to an acquired data format, EDID information matching with the data format; a reader-writer 620 connected to the selector 610 and configured to read the selected EDID information, so as for the display device to display according to the read EDID information.

Optionally, according to an embodiment of the present disclosure, the control apparatus may further comprise a memory 630 in which at least one item of EDID (extended display identification data) information supported by the display device is stored. Optionally, each item of EDID information corresponds to one video signal data format, and the supported timing and bandwidth are different.

Optionally, the memory 630 may also be located outside the control apparatus as a separate memory device and communicate with the control apparatus via a bus.

Optionally, according to an embodiment of the present disclosure, the control apparatus may further comprise a data analyzer 640 connected to the selector 610 and configured to perform data format analysis on the video signal inputted from the source device and sending an analysis result to the selector.

Optionally, the control apparatus may further comprise a communication interface 650 connected to the source device and the data analyzer and configured to receive the video signal inputted from the source device and supplying it to the data analyzer.

Optionally, according to an embodiment of the present disclosure, the data format may comprise a resolution corresponding to the video signal.

Optionally, according to an embodiment of the present disclosure, the reader-writer 620 may also be connected to the memory 630 and configured to read the EDID information stored in the memory according to the user's instruction and transmitting it to the display device. Thereby, the stored EDID information can be displayed to the user for the user to select or preset the EDID information to be used by the display device.

Optionally, according to an embodiment of the present disclosure, the reader-writer 620 is also connected to the memory 630 and configured to write the modified EDID information into the memory 630 according to a modification made by the user to the EDID information displayed on the display device. Thereby, the EDID information stored in the memory may be modified according to the setting made by the user.

Optionally, according to an embodiment of the present disclosure, when the data analyzer analyzed that a resolution of the inputted video signal is higher than a resolution supported by the display device, the selector selects the highest resolution stored by the memory for the display device to display.

Optionally, according to an embodiment of the present disclosure, when the EDID information matching with the resolution of the inputted video signal is not stored in the memory, the selector selects the resolution closest to the resolution for the display device to display.

Optionally, according to an embodiment of the present disclosure, when the EDID information selected by the user is received, the reader-writer supplies the selected EDID information to the source device via a communication interface, so that the source device modifies the data format of the outputted video signal according to the EDID information. Thereby, the source device is made to correspondingly modify the data format of the signal outputted to the display device according to the stored EDID information, so as to be compatible with the display device.

Optionally, according to an embodiment of the present disclosure, the various components included in the control apparatus may be implemented fully by hardware using at least one of an application specific integrated circuit (ASIC), a field programmable gate array (FPGA), or a programmable logic device (PLD); or may also be implemented by using a hardware, such as a digital signal processor (DSP), a micro-control unit (MCU), a central processing unit (CPU), etc. in combination with program instructions stored in the memory to achieve the functions thereof.

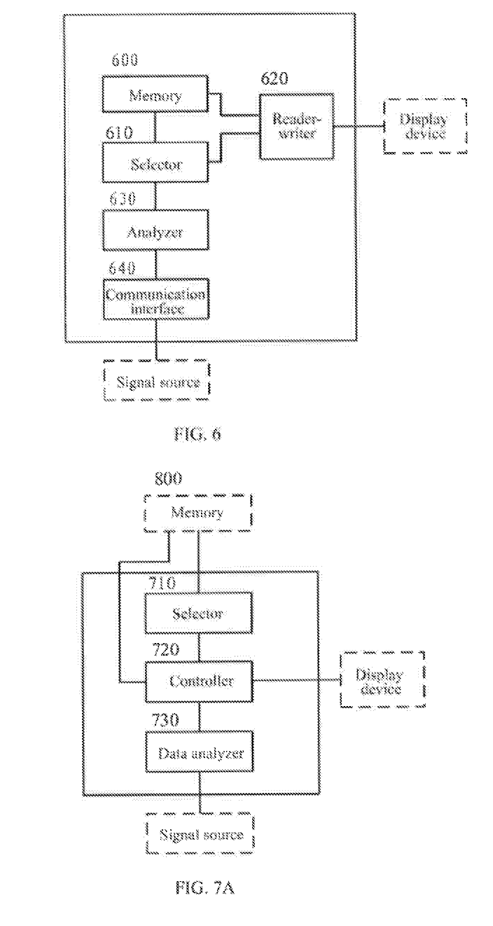

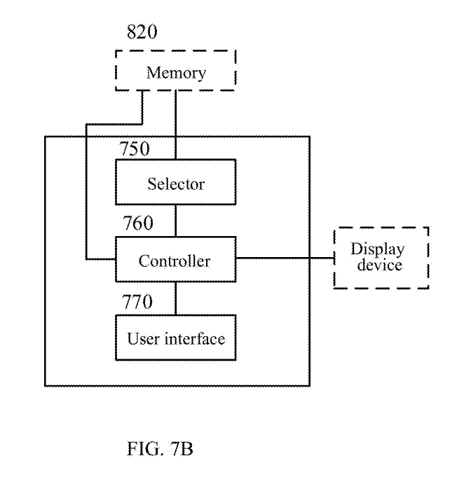

FIG. 7A illustrates a control apparatus for a display device according to an embodiment of the present disclosure. Similar to the control apparatus described in FIG. 6, the control apparatus comprises: a selector 710 configured to select, according to an acquired data format, stored EDID information matching with the data format, and a controller 720 connected to the selector and configured to control, according to the selected EDID information, the display device to display the video signal in a corresponding data format. Optionally, the control apparatus may also be connected to an external memory 800, wherein the memory 800 stores a plurality of items of EDID (extended display identification data) information supported by the display device.

Optionally, each item of EDID information corresponds to one video signal data format, and the supported timing and bandwidth range are different.

Alternatively, the memory 800 may be integrated inside the control apparatus as its internal memory.

As shown in FIG. 7A, the control apparatus further comprises: a data analyzer 730 connected to the controller 720 and configured to analyze a data format of an inputted video signal and sending an analysis result to the controller; the controller 720 controls, according to the analyzed data format, the selector to select the matching EDID information stored in the memory so as for the source device to read, and to select a proper resolution for the display device to display.

FIG. 7B illustrates another control apparatus for a display device according to an embodiment of the present disclosure. Similar to the control apparatus described with reference to FIG. 7A, the control apparatus comprises: a selector 750 configured to search for and selecting, according to an acquired data format, the EDID information stored in the memory and matching with the data format, and a controller 760 connected to the selector and configured to control, according to the selected EDID information, the display device to display according to a corresponding data format. Unlike FIG. 7A, the control apparatus further comprises a graphical user interface (GUI) 770. In fact, the control apparatus may have a dedicated user interface or may use the controlled display device via a communication interface as a user interface to display the stored EDID information to the user for the user selection, and may also preset or adjust EDID information according to needs of the user. Optionally, the control apparatus may also be connected to an external memory 820, wherein the memory 820 stores a plurality of items of EDID (extended display identification data) information supported by the display device. Optionally, each item of EDID information corresponds to one video signal data format, and the supported timing and bandwidth range are different.

Alternatively, the memory 820 may also be integrated inside the control apparatus as its internal memory.

Optionally, the controller may control the selector to select the matching EDID information stored in the memory for the source device to read, and select a proper resolution for the display device to display, according to the data format selected by the user on the user interface.

Optionally, the controller may modify the EDID information stored in the memory according to the EDID information inputted by the user, so as to adjust the EDID setting for the display device promptly as needed.

According to an embodiment of the present disclosure, there is provided a display device comprising the control apparatus as described above.

According to the embodiments of the present disclosure, it is possible to store a plurality of EDID data in advance to correspond to different data formats of the video signal respectively, and select, according to a data format of a signal inputted from the source device or a data format inputted by the user, matching EDID data for the display device to use. In this way, compatibility between the display device and the source device is improved, and display resolution of the display device can be utilized maximally.

The above described merely are specific implementations of the present disclosure, but the protection scope of the present disclosure is not limited thereto, modification and replacement which can be easily conceivable for those skilled in the art within the technical range revealed by the present disclosure all fall into the protection scope of the present disclosure. Therefore, the protection scope of the present disclosure is based on the protection scope of the claims.

The present application claims priority of the Chinese Patent Application No. 201610500242.6 filed on Jun. 29, 2016, the entire disclosure of which is hereby incorporated by reference as part of the present application.

1. A control method for a display device, comprising:
selecting matching extended display identification data EDID information according to a data format of an acquired video signal; and
controlling the display device to display the video signal in a corresponding data format according to the selected EDID information.

2. The control method according to claim 1, further comprising:
analyzing an inputted video signal, to acquire the data format of the video signal.

3. The control method according to claim 1, further comprising:
displaying stored EDID information to a user, and obtaining the data format to be used by the display device to display the video signal according to the user's selection.

4. The control method according to claim 1, further comprising:
displaying an interface for setting EDID information to the user, so as for the user to modify the stored EDID information.

5. The control method according to claim 1, wherein the data format of the video signal includes a resolution corresponding to the video signal.

6. The control method according to claim 5, further comprising:
when a resolution of the inputted video signal is higher than a resolution supported by the display device, controlling the display device to display the video signal at the highest resolution supported by the display device.

7. The control method according to claim 5, further comprising:
when the EDID information matching with the resolution of the inputted video signal is not stored, controlling the display device to display at a resolution closest to the resolution of the inputted video signal as supported by the display device.

8. The control method according to claim 1, further comprising:
modifying the data format of the video signal inputted to the display device according to the selected EDID information.

9. A control apparatus for a display device, comprising:
a selector configured to select, according to a data format of an acquired video signal, extended display identification data EDID information matching with the data format; and
a reader-writer connected to the selector and configured to read the selected EDID information, so as for the display device to display the video signal according to the read EDID information.

10. The control apparatus according to claim 9, further comprising:
a data analyzer connected to the selector and configured to analyze a data format of an inputted video signal, and sending an analysis result to the selector.

11. The control apparatus according to claim 9, further comprising:
a memory configured to store at least one item of EDID information supported by the display device.

12. The control apparatus according to claim 11, wherein the reader-writer reads EDID information stored in the memory according to a user instruction, so as to obtain the data format to be used by the display device to display the video signal according to the user's selection.

13. The control apparatus according to claim 11, wherein the reader-writer receives a modification made by the user to the EDID information, and writes the modified EDID information into the memory.

14. The control apparatus according to claim 9, wherein the data format includes a resolution corresponding to the video signal.

15. The control apparatus according to claim 14, wherein when a resolution of the inputted video signal is higher than a resolution supported by the display device, the selector selects the highest resolution supported by the display device for the display device to display.

16. The control apparatus according to claim 14, wherein when the EDID information matching with the resolution of the inputted video signal is not stored, the selector selects a resolution closest to the resolution of the inputted video signal as supported by the display device, for the display device to display.

17. The control apparatus according to claim 9, wherein when the selected EDID information is received, the reader writer supplies the selected EDID information to a source device, so that the source device modifies the data format of the inputted video signal according to the EDID information.

18. A display device, comprising the control apparatus according to claim 9.
